(19) United States
(12) Patent Application Publication
(10) Pub. No.: US 2004/0012730 A1
(43) Pub. Date: Jan. 22, 2004

(54) Electrically shielding light guide for a liquid crystal display

(76) Inventors: Long-Jyh Pan, Taipei Hsien (TW); Kao-Ping Lo, Tao-Yuan Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,460

(22) Filed: Jul. 17, 2002

(51) Int. Cl. G02F 1/1333

(52) U.S. Cl. 349/60

(57) ABSTRACT

A liquid crystal display (LCD) light guide is provided for use in a portable electronic device. The electronic device contains electronic components, a ground pad, an electrically conductive sponge, an LCD module, a light guide, and a light source. The light guide includes a translucent plate having a metallic reflector disposed on one face. The light guide provides illumination to an LCD module and simultaneously acts as a shield against electrostatic discharge and electromagnetic radiation.

### BACKGROUND OF INVENTION

1. Field of the Invention

The present invention relates to a liquid crystal display (LCD), and more specifically to a light guide of a backlit LCD capable of providing electrical shielding.

2. Description of the Prior Art

Backlit LCDs are common devices found in a wide array of modern electronics. A backlit LCD provides information to a user of such a device in a manner that is easily readable in both light and dark ambient conditions. Mobile phones and personal digital assistants (PDAs) are two examples of popular consumer devices that usually employ a backlit LCD.

A typical prior art backlit LCD assembly 10 is illustrated in FIG. 1. The LCD assembly 10 comprises an LCD module 12 for displaying information, a translucent light guide plate 14 disposed under the LCD module 12, a white paper reflector 16 adhered to the bottom of the light guide plate 14, a printed circuit board (PCB) 18 having electronic components 22 disposed thereon, and an array of light emitting diodes (LEDs) 20. A reflective strip is provided above the LED array 20 but is not shown in this figure. The PCB 18 also functions as a chassis to which the other components can be attached. Electronic components 22 are located under the white paper reflector 16. The electronic components 22 control the LEDs 20 and the LCD module 12. The LCD assembly 10, or a variation of it, can be found in many portable devices.

A user can illuminate the LCD module 12 by controlling the electronic components 22 to switch on the LEDs 20. The light emitted by the LEDs 20 enters the translucent light guide plate 14 through a concave edge 14c of the light guide plate 14. The light is internally reflected within the light guide plate 14 before being reflected out a surface adjacent to the LCD module 12 by the reflector 16. The light exits the light guide plate 14 and passes through the LCD module 12 causing the LCD module 12 to be illuminated.

Greater detail of the prior art light guide plate 14 and white paper reflector 16 can be seen in the cross-sectional view of FIG. 2. The light guide plate 14 is made out of a translucent polymer, typically an acryl resin, and has a plurality of recesses 28 formed into one side as shown. The recesses 28 are designed to help scatter light evenly. The reflector 16 is a glossy white paper adhered to the light guide plate 14 using an adhesive. A reflective strip 29 is disposed above the LED array 20 (LED array 20 is not shown in FIG. 2) to help direct light into the light guide plate 14. An arrow 24 indicates light emitted by the LEDs 20 entering the translucent light guide plate 14 through the edge surface 14a. An arrow 26 represents light, which illuminates the LCD module 12, exiting the light guide plate 14 through a face 14b and passing through the LCD module 12. The design of the light guide plate 14 is such that the light 26 is reasonably uniform in intensity when illuminating the LCD module 12.

In U.S. Pat. No. 5,833,517, which is included herein by reference, Konda et al. teaches in much detail how to design and manufacture a light guiding plate similar to the light guide plate 14 described.

The prior art suffers from several problems. The electronic components 22 may produce an electrostatic discharge that can damage the LCD module 12. Additionally, the electronic components are vulnerable to electromagnetic interference originating from outside a device containing the LCD assembly 10. Finally, if the device containing the LCD assembly 10 is a mobile phone, the electronic components 22 can emit electromagnetic radiation that may be harmful to a cellular phone user. Essentially, the prior art lacks an LCD light guide that can shield an LCD module from harmful electrostatic discharge by electronic components, and at the same time serve as a shield for electromagnetic radiation.

### SUMMARY OF INVENTION

It is therefore a primary objective of the claimed invention to provide an LCD light guide capable of providing electrical shielding to solve the problems of the prior art.

Briefly summarized, the preferred embodiment of the claimed invention comprises a portable electronic device including electronic components, a ground pad electrically connected to the electronic components, a conductive sponge electrically connected to the ground pad, an LCD module for displaying output according to the electronic components, and a light guide for backlighting the LCD module. The light guide includes a translucent plate having a first major face adjacent to the LCD module, and a second major face adjacent to the electronic components. The translucent plate has a metallic shield directly disposed on the second major face that is electrically connected to the conductive sponge. A light source is further provided and is controlled by the electronic components to emit light into the translucent plate of the light guide to illuminate the LCD module.

It is an advantage of the claimed invention that the light guide illuminates the LCD module, while simultaneously shielding the LCD module from electrostatic discharge of the electronic components and serving as a shield for electromagnetic radiation.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a perspective view of a prior art backlit LCD assembly.

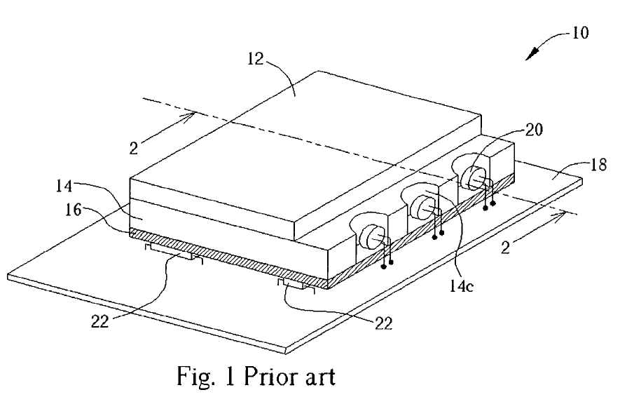

FIG. 2 is a cross-sectional view of the LCD module, the light guide plate, and the reflector shown in FIG. 1.

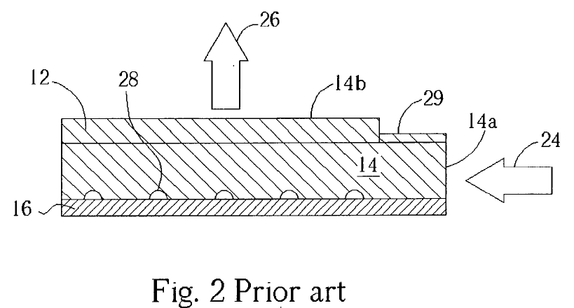

FIG. 3 is perspective view of a backlit LCD assembly according to the present invention.

FIG. 4 is a cross-sectional view of the LCD module, the light guide plate, and the metallic shield shown in FIG. 3.

FIG. 5 is a schematic diagram of the shielding effect of the metallic shield shown in FIG. 3

### DETAILED DESCRIPTION

The preferred embodiment describes the present invention employed in a mobile phone as an example. The teachings of the present invention, however, enable it to be used successfully in a wide variety of other electronic devices that require backlighting of a liquid crystal display (LCD) module.

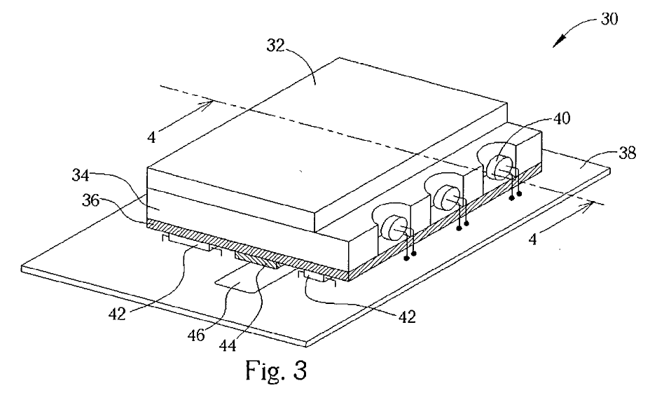

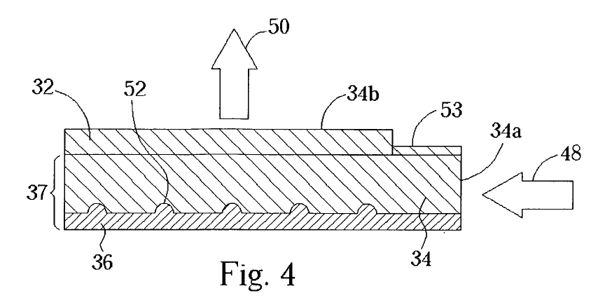

A backlit LCD assembly 30 according to the present invention is shown in FIG. 3. The LCD assembly 30 includes an LCD module 32 for displaying information, a translucent light guide plate 34 made of acryl resin disposed under the LCD module 32, a reflective metallic shield 36 disposed on a bottom side of the light guide plate 34, a printed circuit board (PCB) 38 with electronic components 42 disposed thereon, and an array of light emitting diodes (LEDs) 40. The LCD assembly 30 also includes a reflective strip (item 53 of FIG. 4) that is not shown in FIG. 3, and which is disposed on the light guide plate 34 above the LEDs 40. The electronic components 42 are located under the metallic shield 36. In the preferred embodiment, the metallic shield 36 is made of aluminum, which is sputtered onto the bottom surface of the light guide plate 34. The PCB 38 functions as a chassis to which the other components can be attached. The PCB 38 includes a metal ground pad 46 disposed onto its surface. The components 42 and a power supply (not shown) can be electrically connected to the ground pad 46. The shield 36 is also electrically connected to the ground pad 46, and in the preferred embodiment this is performed by an electrically conductive sponge 44. Other materials may be used in place of the conductive sponge 44, such as a direct metallic interconnect made of copper, aluminum or some other electrically conductive material. The electronic components 42 control the LCD module 32 and the LED array 40, and provide the appropriate functionality of a portable electronic device, in this case a mobile phone, which has output displayed by the LCD module 32.

Details of the manufacture of the combined translucent plate 34 and shield 36, or electrically shielding light guide 37, is illustrated in FIG. 4. A plurality of recesses 52 is formed into the bottom surface of translucent plate 34. The recesses 52 are formed having a specifically designed uniform illumination pattern. A reflective Mylar strip 53 is provided above the LED array 40, not shown in FIG. 4, to help guide light into the translucent plate 34. The aluminum shield 36 is disposed directly onto the bottom surface of the translucent plate 34 by a metal sputtering process. In lieu of metal sputtering, chemical vapor deposition or plasma vapor deposition could be used to form the shield 36. Any of these processes results in the recesses 52 being filled with deposited material as illustrated in FIG. 4. Furthermore, the shield 36 can be made of any conductive metallic material that can be formed into a thin layer on the light guide plate 34. Besides providing a uniform scattering of light, the recesses 52 increase the overall contact surface area between the metal layer shield 36 and the translucent plate 34, and thus provide increased bonding strength of the shield 36 to the bottom surface of the translucent plate 34.

FIG. 4 also illustrates the backlighting feature of the light guide 37. Light 48 is emitted by the LED array 40 when the electronic components 42 activate the backlight feature of the LCD assembly 30. The light 48 is emitted into the translucent plate 34 through an edge surface 34a, and is internally reflected within the translucent plate 34 and scattered by the recesses 52. Light is then reflected up through the LCD module 32 by the reflective aluminum shield 36, as indicated by arrow 50, to exit the translucent plate 34 through a surface 34b such that the LCD module 32 is illuminated. It should be noted that by modifying the material composition of the reflective shield 36, by say using magnesium rather than aluminum, results in a different intensity and quality of light 50.

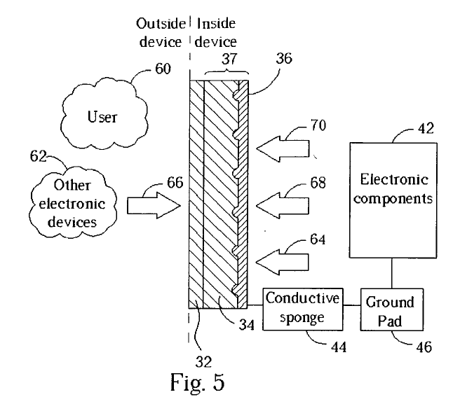

The electrical shielding feature of the present invention is shown in FIG. 5. FIG. 5 is a schematic diagram illustrating a user 60 using a mobile phone that includes the LCD assembly 30 in an environment that has other electronic devices 62. For clarity, only the components relevant to the electrical shielding feature of the LCD assembly 30 are shown. Note that FIG. 5 is divided by a dashed line to represent the,separation of components inside the mobile phone from entities outside the mobile phone. The electrical shielding feature provided by light guide 37 is threefold.

First, the electronic components 42 can produce an electrostatic discharge 64 that has the potential to damage the LCD module 32. If the electronic components 42 produce an electrostatic discharge 64, the aluminum shield 36 grounds the electrostatic discharge 64 to the ground pad 46 via the conductive sponge 44. In this way, damage to the LCD module 32 is prevented.

Second, electromagnetic interference (EMI) 66 in the form of electromagnetic radiation can be emitted by other electronic devices 62. The aluminum shield 36 grounds and reflects the EMI 66 to prevent malfunctioning of the electronic components 42. Conversely, the electronic components 42 may emit electromagnetic radiation 68 that could affect the operations the other electronic devices 62. This type of radiation 68 is also grounded and reflected by the shield 36. Generally, the material, size, and thickness of a given metallic shield 36, as well as the exact location of the shield 36 with respect to electronic components 42 in a portable electronic device are designed considering the functionality and intended use of the device to maximize electromagnetic compatibility of the device with its environment.

Third, electromagnetic radiation 70 emitted by the electronic, components 42 that can potentially affect the health of the user 60 are reflected and grounded by the aluminum shield 36. This is an advantage of the present invention and is of particular importance as applied to mobile phones. The light guide 37 having the aluminum shield 36, being situated directly between the electronic components 42 and the user 60, can reduce the total specific absorption rate (SAR) of microwaves by the user 60. As mentioned in the previous paragraph, the precise design of the shield 36 can be optimized depending on specific parameters.

In contrast to the prior art, the present invention light guide has a metallic shield disposed directly onto a surface, such that the metallic shield can prevent an electrostatic discharge from damaging an LCD module and reduce electromagnetic radiation. The metallic shield reduces EMI originating from outside a device utilizing the present invention light guide, and likewise reduces electromagnetic radiation being emitted by electronic components in the device. The present invention light guide also reduces the amount of harmful electromagnetic radiation that may be absorbed by a user of the device. Concurrent with these features, the present invention light guide also simultaneously provides illumination to the LCD module.

Those skilled in the art will readily observe that numerous modifications and alterations of the device may be made while retaining the teachings of the invention.

Accordingly, the above disclosure should be construed as limited only by the metes and bounds of the appended claims.

What is claimed is:

1. A portable electronic device comprising:
electronic components providing at least a function of the portable electronic device;
a ground pad electrically connected to the electronic components;
an electrically conductive material electrically connected to the ground pad;
a Liquid Crystal Display (LCD) module for displaying output according to the electronic components;
a light guide for backlighting the LCD module, the light guide comprising:
a translucent plate having a first major face adjacent to the LCD module, and a second major face adjacent to the electronic components; and
a metallic shield directly disposed on the second major face of the translucent plate and electrically connected to the conductive material; and
a light source controlled by the electronic components to emit light into the translucent plate of the light guide;
whereby the light guide shields the LCD module from electrostatic discharge of the electronic components, and serves as a shield for electromagnetic radiation.

2. The portable electronic device of claim 1 wherein the translucent plate has a plurality of recesses formed into the second major face to scatter internally reflected light, and the metallic shield reflects the scattered light to exit the first face of the translucent plate.

3. The portable electronic device of claim 2 further comprising at least a reflecting strip adhered to the translucent plate for directing light from the light source into the translucent plate.

4. The portable electronic device of claim 2 wherein the light source is a Light Emitting Diode (LED).

5. The portable electronic device of claim 1 wherein the function of the electronic components is that of a mobile phone or a personal digital assistant (PDA).

6. The portable electronic device of claim 1 wherein the electrically conductive material is an electrically conductive sponge.

7. A method for providing electrical shielding comprising:
providing electronic components that provide functionality associated with the portable electronic device;
providing a ground pad electrically connected to the electronic components;
providing an electrically conductive material electrically connected to the ground pad;
providing an LCD module for displaying output according to the electronic components;
providing a translucent plate having a first major face adjacent to the LCD module, and a second major face adjacent to the electronic components; and
disposing a metallic shield onto the second major face of the translucent plate, the metallic shield electrically connected to the electrically conductive material.

8. The method of claim 7 wherein the metallic shield is disposed onto the second major face of the translucent plate by a metal sputtering process.

9. The method of claim 7 wherein the metallic shield grounds and reflects electromagnetic radiation.

10. The method of claim 7 wherein the metallic shield grounds electrostatic discharge originating from the electronic components, dissipating the electrostatic discharge to the ground pad through the conductive material.

11. The method of claim 7 wherein the electrically conductive material is an electrically conductive sponge.
